(19) United States
(12) Patent Application Publication
(10) Pub. No.: US 2006/0194937 A1
(43) Pub. Date: Aug. 31, 2006

(54) Method for the production of organopolysiloxane copolymers and use thereof

(76) Inventors: Oliver Schäfer, Burghausen (DE); Sabine Delica, Munich (DE)

Correspondence Address: BROOKS KUSHMAN P.C., 1000 TOWN CENTER, TWENTY-SECOND FLOOR, SOUTHFIELD, MI, 48075, US

(21) Appl. No.: 10/551,110

(22) PCT Filed: Mar. 11, 2004
(86) PCT No.: PCT/EP04/02533

§ 371 Date: Sep. 26, 2005

(30) Foreign Application Priority Data
Mar. 27, 2003 (DE) 103 13 938.9

(51) Int. Cl. C08G 77/04

(52) U.S. Cl. 528/28

(57) ABSTRACT

A method for the solvent-free, continuous production of organopolysiloxane/polyurea/polyurethane block copolymers involves reacting amino-functional siloxanes with polyisocyanates and organic polyhydroxy compounds. The organopolysiloxane/polyurea/polyurethane block copolymers produced by means of the inventive method are useful for numerous purposes, for example as elastomers, caulks, sealants, and films.

The invention relates to a method for the solvent-free production of organopolysiloxane/polyurea/polyurethane block copolymers and to the use thereof.

Within wide ranges, the properties of polyurethanes and silicone elastomers are complementary. Polyurethanes are distinguished by their outstanding mechanical strength, elasticity, very good adhesion, abrasion resistance, and ease of processing by extrusion from the melt. Silicone elastomers, on the other hand, possess an excellent temperature, UV, and weathering stability. They retain their elastic properties at relatively low temperatures and therefore also exhibit no propensity toward embrittlement. In addition they possess specific water repellency and antistick surface properties.

Through the combination of urethane polymers and silicone polymers, materials having good mechanical properties are obtainable which at the same time are notable for processing possibilities that are greatly simplified as compared with the silicones, and yet they continue to possess the positive properties of the silicones. The combination of the advantages of both systems can therefore lead to compounds having low glass transition temperatures, low surface energies, improved thermal and photochemical stabilities, low water absorption, and physiologically inert materials. Adequate compatibilities have only been achieved in a few specific cases by production of polymer blends. Not until the production of polydiorganosiloxane-urea block copolymers, described in I. Yilgör, Polymer, 1984 (25), 1800 and in EP-A-250248 was it possible to achieve this objective. Starting materials used in this case for the siloxane-urea copolymers, as siloxane units, are aminoalkyl-terminated polysiloxanes. These form the soft segments in the copolymers, in a similar way to the polyethers in pure polyurethane systems. Hard segments used are common diisocyanates, which may also be modified by the addition of diamines, such as 1,6-diaminohexane, for example, in order to attain higher strengths. The reaction of the amino compounds with isocyanates is spontaneous and as a general rule does not require any catalyst.

The silicone and isocyanate polymer units are miscible with no problems within a wide range. As a result of the strong interactions of the hydrogen bonds between the urea units, these compounds possess a defined softening point, and thermoplastic materials are obtained. The use of these thermoplastic materials is conceivable in numerous applications: in sealants, adhesives, as material for fibers, as a plastics additive, e.g., as an impact modifier or flame retardant, as material for defoamer formulations, as a high-performance polymer (thermoplastic, thermoplastic elastomer, elastomer), as packaging material for electronic components, in insulating or shielding materials, in cable sheaths, in antifouling materials, as an additive for cleaning, cleansing or polishing products, as an additive for body care products, as a coating material for wood, paper and board, as a mold release agent, as biocompatible material in medical applications such as contact lenses, as coating material for textile fibers or textile fabrics, as coating material for natural substances such as leather and furs, for example, as material for membranes, and as material for photoactive systems for lithographic techniques, optical data protection or optical data transfer, for example.

There is a need, therefore for siloxane-urea copolymers which have high molecular weights and, as a result, favorable mechanical properties such as high tensile strengths and breaking elongations, for example, and in addition exhibit good processing properties, such as low viscosity at elevated temperatures, and freedom from solvent. A further curing step for crosslinking these materials is not necessary, since owing to meltable constituents they have physical crosslinking sites which can be broken down again and reoriented by an increase in temperature.

In European patent EP 0 250 248 and in Yilgör et. al., the corresponding polymers are produced in solution, however, which is an expensive process for industrial use, since the solvent has to be removed, in an additional process step. European patent EP 0 822 951 describes a continuous reactor process for the solvent-free synthesis of such siloxane-urea block copolymers, in which the starting materials are reacted directly with one another. In order to improve the mechanical properties of pure siloxane-urea copolymers, organic diamines are additionally added in small amounts there, so generating further urea groups and hence increasing the tensile strength of the corresponding polymers. A disadvantage of this process, however, is the sharp increase in the softening temperatures of the corresponding siloxane-urea copolymers as a result of the use of diamines of low molecular mass. During production and/or processing this leads to a sharp increase in the operating temperatures within the reactor as the proportion of low molecular mass diamines goes up. Since, however, the decomposition temperatures of siloxane-urea copolymers are around 200° C., increasing the reaction temperatures in the operation of the reactor above this temperature is not desirable or, in some cases, is impossible. Consequently, the amount of low molecular mass diamines cannot be increased ad infinitum either. If this critical amount is exceeded, a continuous reactor operation is no longer possible, since the material is no longer obtained in a viscosity which allows it, for example, to be extruded. As a general rule, in the case of a reactive extrusion, only up to a maximum of 4% by weight of organic diamines can be added without hindering the uniform removal of the polymer from the extruder and preventing a continuous operation. If the proportion of organic diamines is raised, it leads to hardening of the polymer in the extruder, which results in the extruded strand breaking or in the extruder becoming blocked, or in a very sharp variation in the thickness of the extruded strand, so that subsequent processing by pelletizing is no longer possible as a continuous procedure with the common technical means.

With these materials, in coating applications, for example, obtaining uniformly thin coats is made much more difficult. Furthermore, the majority of organic primary diamines are solids, necessitating heatable pumps and pipes for the continuous conveying of these substances, which is a technical drawback. Owing to the aminic character of these organic compounds, they have an unpleasant odor and also a certain propensity toward yellowing, which is manifested above all, with distinct disadvantage, in compounds with the high temperatures needed for extrusion. This is also the reason, for example, why pure organic polyurea polymers are generally not processed by extruder methods, since they possess so many polar groups which bring the softening range of the material up to the decomposition temperatures of the urea bond. RIM processes are commonly used here; in other words, the polymerization reaction takes place in the mold.

As shown by Ho et al. (Macromolecules 1993, 26, 7029-7036), the reaction of siloxane diamines with diisocyanates and organic bishydroxy compounds likewise produces thermoplastic products which have sufficient mechanical strength and can be processed in a temperature range below 200° C. without yellowing. In contradistinction to the diamino compounds mentioned, the organic dihydroxy compounds can also still be used in weight fractions of more than 20%.

It is found in this context that the softening temperatures, above a certain fraction, no longer increase but instead remain almost constant, and yet the mechanical properties are improved further. The process described by Ho et al., however, is a two-stage process, in which the second polymerization stage is carried out in dilute solution. For an industrial process this has the great disadvantage that it is necessary subsequently to remove the solvent again.

The object of the present invention, then, was to provide a method for the continuous, solvent-free production of thermoplastic silicone-urea copolymers combining improved mechanical properties with good extrusion properties in a temperature range of 80-190° C. The method was also intended to overcome the difficulty that the reaction of amines with isocyanates proceeds much more rapidly than the reaction of alcohols with isocyanates and that therefore, in a continuous method, a two-stage reaction must be quantitatively concluded within a defined residence time, in which, inter alia, there are separation phenomena or viscosity increases in the polymer melt.

Surprisingly it has now been found that in the continuous reaction of siloxane diamines with diisocyanates and organic bishydroxy compounds in a reactor, thermoplastic products are obtained which have sufficient mechanical strength and can be processed in a temperature range below 200° C. without yellowing. This method has the advantage in particular that the bishydroxy compounds used are generally liquids, and can therefore be conveyed easily by means of simple pumps, and do not tend toward yellowing. In contradistinction to the aforementioned diamino compounds, the organic dihydroxy compounds can even still be used in weight fractions of more than 20%. It is found here that, above a certain fraction, the softening temperatures no longer rise but instead remain virtually constant, and yet the mechanical properties are improved still further.

The invention accordingly provides a method for the production of an organopolysiloxane/polyurea/polyurethane block copolymer (A) of the general formula (1):
—[[—NR′—X—SiR₂—[—O—SiR₂—]ₙ—X—NR′—CO—NH—Y—NH—CO—]ₐ——[—O-D-O—CO—NH—Y—NH—CO—]_{b}—[—NR-D′-NR—CO—NH—Y—NH—CO—]_{b′}——[—NR′—X—SiR₂—[—O—SiR₂—]ₙ—X—NR′—CO—NH—Y—NH—CO—NH—Y—NH—CO—]_{c}]_{d}—
which is characterized in that an aminoalkylpolydiorganosiloxane of the general formula (2):
HR′N—X—[SiR₂O]ₙSiR₂—X—NR′H
is reacted with diisocyanate of the general formula (3):
OCN—Y—NCO
bishydroxy compounds of the general formula (4):
HO-D-OH
and if desired small amounts of diamino compounds of the general formula (5):
HRN-D′-NHR,
where
R is a monovalent hydrocarbon radical having 1 to 20 carbon atoms which is unsubstituted or substituted by fluorine or chlorine,
X is an alkylene radical having 1 to 20 carbon atoms, in which nonadjacent methylene units may be replaced by —O— groups,
R′ is hydrogen or an alkyl radical having 1 to 10 carbon atoms,
Y is a divalent hydrocarbon radical having 1 to 20 carbon atoms which is unsubstituted or substituted by fluorine or chlorine,
D is an alkylene radical having 1 to 700 carbon atoms which is unsubstituted or substituted by fluorine, chlorine, C₁-C₆ alkyl or C₁-C₆ alkyl esters and in which nonadjacent methylene units may be replaced by —O—, —COO—, —OCO— or —OCOO— groups,
D′ is an alkylene radical having 1 to 700 carbon atoms which is unsubstituted or substituted by fluorine, chlorine, C₁-C₆ alkyl or C₁-C₆ alkyl esters and in which nonadjacent methylene units may be replaced by —O—, —COO—, —OCO— or —OCOO— groups,
n is a number from 1 to 4000,
a is a number which is at least 1,
b is a number greater than 1,
b′ is a number from 0 to 40,
c is a number from 0 to 30, and
d is a number greater than 0.

The aminoalkylpolydiorganosiloxane of the general formula (2) can be produced via known techniques such as equilibration reactions, hydrosilylation reactions or functionalization reactions with reactive amino-silanes.

Preferably R is a monovalent hydrocarbon radical having 1 to 6 carbon atoms, which in particular is unsubstituted. Particularly preferred radicals R are methyl, ethyl, vinyl, and phenyl.

Preferably X is an alkylene radical having 2 to 10 carbon atoms. Preferably the alkylene radical X is uninterrupted.

Preferably the group NR′ is an NH group.

Preferably Y is a hydrocarbon radical having 3 to 13 carbon atoms, which is preferably unsubstituted.

Preferably Y is an aralkylene radical or linear or cyclic alkylene radical.

Preferably D is an alkylene radical having at least 2, in particular at least 4, carbon atoms and not more than 12 carbon atoms. Likewise preferably D is a polyoxyalkylene radical, especially polyoxyethylene radical or polyoxypropylene radical, having at least 20, in particular at least 100, carbon atoms and not more than 700, in particular not more than 200, carbon atoms. With particular preference the radical D is unsubstituted.

n is preferably a number which is at least 3, in particular at least 25, and preferably not more than 800, in particular not more than 400, more preferably. not more than 250.

Preferably a is a number which is not more than 50.

Preferably b is a number which is at least 5 but not more than 100, in particular not more than 50.

c is preferably a number which is not more than 10, in particular not more than 5.

The polydiorganosiloxane-urea-urethane copolymer of the general formula (1) exhibits high molecular weights and good mechanical properties in conjunction with good processing properties.

The chain extender of the general formula (6) may in a further preferred embodiment also be reacted prior to the reaction in the second step with diisocyanate of the general formula (5). If desired, water can also be used as chain extender.

Examples of the diisocyanates of the general formula (5) that are to be used are aliphatic compounds such as isophorone diisocyanate, hexamethylene 1,6-diisocyanate, tetramethylene 1,4-diisocyanate and methylenedicyclohexyl 4,4′-diisocyanate or aromatic compounds such as methylenediphenyl 4,4′-diisocyanate, toluene 2,4-diisocyanate, toluene 2,5-diisocyanate, toluene 2,6-diisocyanate, m-phenylene diisocyanate, p-phenylene diisocyanate, m-xylene diisocyanate, tetramethyl-m-xylene diisocyanate or mixtures of these isocyanates. An example of commercially available compounds are the diisocyanates of the DESMODUR® series (H,I,M,T,W) of Bayer AG, Germany. Preference is given to aliphatic diisocyanates in which Y is an alkylene radical, since these materials lead to the resulting copolymers exhibiting improved UV stabilities, which is of advantage when the polymers are used outdoors.

In addition it is possible to copolymerize polyalkylenes or polyoxyalkylenes. These are preferably largely free from contaminations from polyoxyalkylenes with a functionality of one, three or more. In this context it is possible to use polyetherpolyols, poly-tetramethylenediols, polyesterpolyols, polycaprolactonediols, and also α,ω-OH-terminated polyalkylenes based on polyvinyl acetate, and polyvinyl acetate-ethylene copolymers, polyvinyl chloride copolymer, polyisobutyldiols. It is preferred to use polyoxyalkyls, more preferably polypropylene glycols. Compounds of this kind are available commercially as base materials, inter alia, for flexible polyurethane foams and for coating applications, with molecular masses Mn of up to more than 10 000. Examples thereof are the BAYCOLL® polyetherpolyols and polyesterpolyols from Bayer AG, Germany or the Acclaim® polyetherpolyols from Lyondell Inc., USA. Also comprehended by dihydroxy compounds for the purposes of the invention, likewise, are bishydroxyalkylsilicones, as sold for example by Goldschmidt under the name Tegomer H-Si 2111, 2311, and 2711. These may be used inter alia to influence the softening ranges of the resultant copolymers within certain ranges.

The above-described copolymers of the general formula (1) are produced in a continuous operation. It is essential in this case that optimum and homogeneous commixing of the constituents takes place for the chosen polymer mixture under the reaction conditions.

The production ought to take place generally in the absence of moisture and under inert gas, commonly nitrogen or argon, for the purpose of improved reproducibility.

The order in which the components employed are metered in is generally not arbitrary. It is necessary to ensure that separation phenomena and incompatibility phenomena are minimized as far as possible. Preferably the low molecular mass components such as the isocyanate and the hydroxy compound are metered into the reactor first, with thorough mixing being obtained without the components, in the absence of corresponding catalysts, reacting with one another to any great extent; in other words, they remain in the liquid state. Subsequently the aminosilicones and the catalyst are metered in, and immediately there is reaction between the amino groups and the isocyanate groups, which can be perceived from a sharp increase in viscosity. In this case, however, owing to its previous mixing with the isocyanate, the diol component is likewise already in solution in the polymer and in further operation is able to react with the isocyanate groups still present in the polymer, this reaction being accompanied by an increase in molecular weight. In contrast to Ho et al., therefore, in this method, in one step, first the urea groups are formed and only then, subsequently, are the urethane groups formed, without it being necessary as well to remove solvent.

The reaction takes place preferably by addition of a catalyst. Suitable catalysts for the production are dialkyltin compounds, such as dibutyltin dilaurate, dibutyltin diacetate, for example, or amines such as N,N-dimethylcyclohexanamine, 2-dimethylaminoethanol, 4-dimethylaminopyridine, for example.

Preferred applications of the polydiorganosiloxane-urea-urethane copolymers of the general formula (1) are uses as a constituent in adhesives and sealants, as base material for thermoplastic elastomers such as, for example, cable sheaths, hoses, seals, keyboard mats, for membranes, such as membranes with selective gas permeability, as additives to polymer blends, or for coating applications, e.g., in antistick coatings, tissue-compatible coatings, flame-retarded coatings, and as biocompatible materials.

All of the above symbols in the above formulae have their definitions in each case independently of one another.

In the examples below, unless indicated otherwise in each specific case, all amounts and percentages are by weight and all pressures are 0.10 MPa (abs.). All viscosities were determined at 20° C. The molecular masses were determined by means of GPC in toluene (0.5 ml/min) at 23° C. (column: PLgel Mixed C+PLgel 100 A, detector: RI ERC7515). Softening ranges were determined by means of thermal mechanical analysis (TMA).

### EXAMPLE 1

(Not Inventive)

A 2000-ml flask was charged with 1700 g of octamethyl-cyclotetrasiloxane (D4) and 124 g of bisaminopropyl-tetramethyldisiloxane (M=248 g/mol). Subsequently 1500 ppm of tetramethylammonium hydroxide were added and the mixture was equilibrated at 100° C. for 12 hours. It was then heated at 150° C. for 2 hours and subsequently 220 g of D4 ring were distilled off. This gave a bisaminopropyl-terminated polydimethylsiloxane having a molecular weight of 3200 g/mol.

### EXAMPLE 2

(Not Inventive)

A 2000-ml flask with dropping funnel and reflux condenser was charged with 1500 g of bishydroxy-terminated polydimethylsiloxane (molar weight 3000 g/mol). Subsequently at 50° C. 116 g of 1-(3-aminopropyl-1,1-dimethylsilyl)-2,2-dimethyl-1-aza-2-silacyclopentane were added dropwise and the mixture was then left to stand for 1 hour. This gave a glass-clear bisaminopropyl-terminated polydimethylsiloxane having a molecular weight of 3200 g/mol, which according to 29Si NMR was free from Si—OH groups.

### EXAMPLE 3

(Not Inventive)

A 2000-ml flask with dropping funnel and reflux condenser was charged with 1080 g of bishydroxy-terminated polydimethylsiloxane (molar weight 10 800 g/mol). Subsequently at a temperature of 60° C. 23.2 g of 1-(3-aminopropyl-1,1-dimethylsilyl)-2,2-dimethyl-1-aza-2-silacyclopentane were added dropwise and the mixture was then stirred at 80° C. for 5 hours. Cooling gave a bisaminopropyl-terminated polydimethylsiloxane having a molecular weight of 11 000 g/mol, which according to 29Si NMR was free from Si—OH groups.

### EXAMPLES 4 and 5-10

(Not Inventive)

In a twin-screw extruder from Collin, Ebersberg, Germany with 6 heating zones, under a nitrogen atmosphere, isophorone diisocyanate (IPDI) having a molecular weight of 222 g/mol and butanediol were metered in in the first heating zone and the aminopropyl-terminated silicone oil from Example 2, with a molecular weight of 3200 g/mol, was metered in in the second heating zone. The aminopropyl-terminated silicone oil also had 200 ppm of dibutyltin dilaurate added to it. The temperature profile of the heating zones was programmed as follows: zone 1 30° C., zone 2 100° C., zone 3 160° C., zone 4 180° C., zone 5 160° C., zone 6 125° C. The rotational speed was 50 rpm. Taken off continuously from the die of the extruder was colorless polydimethylsiloxane-polyurea-polyurethane block copolymer, which was pelletized after cooling.

| | | | | | | Softening |
|---|---|---|---|---|---|---|
| | Metering [g/min] | | | Silicone | Tensile | point |
| Exam- | | Amino- | Butane- | content | strength | TMA |
| ple | IPDI | silicone | diol | [%] | [MPa] | [° C.] |
| 4 | 0.248 | 4 | 0 | 94 | 0.8 | 80 |
| 5 | 0.335 | 4 | 0.034 | 92 | 0.8 | 81 |
| 6 | 0.360 | 4 | 0.044 | 91 | 0.8 | 83 |
| 7 | 0.403 | 4 | 0.064 | 90 | 1.1 | 96 |
| 8 | 0.495 | 4 | 0.103 | 87 | 1.6 | 119 |
| 9 | 0.741 | 4 | 0.205 | 81 | 4.7 | 142 |
| 10 | 1.19 | 4 | 0.395 | 72 | 6.4 | 158 |

It is apparent that as the amount of butanediol goes up there is an increase in the tensile strengths of the polymers and also in their softening points.

### EXAMPLE 11

(Not Inventive)

In a twin-screw extruder from Collin, Ebersberg, Germany with 6 heating zones, under a nitrogen atmosphere, isophorone diisocyanate (IPDI) having a molecular weight of 222 g/mol at 1.09 g/min and Dytek™ A (methyldiaminopentane) at 0.395 g/min were metered in in the first heating zone and aminopropyl-terminated silicone oil from Example 2, with a molecular weight of 3200 g/mol at 4 g/min, was metered in in the second heating zone. The temperature profile of the heating zones was programmed as follows: zone 1 30° C., zone 2 100° C., zone 3 180° C., zone 4 210° C., zone 5 180° C., zone 6 140° C. The rotational speed was 50 rpm. Taken off from the die of the extruder in some cases were polydimethylsiloxane-polyurea block copolymers, which were pelletized after cooling. Continuous operation, however, was not possible, since the extruder underwent clogging again and again.

### EXAMPLE 12

In a twin-screw extruder from Collin, Ebersberg with 6 heating zones, under a nitrogen atmosphere, isophorone diisocyanate (IPDI) having a molecular weight of 222 g/mol at 0.75 g/min and butanediol at 0.205 g/min were metered in in the first heating zone and the aminopropyl-terminated silicone oil from Example 3, with a molecular weight of 11 000 g/mol at 13.5 g/min, was metered in in the second heating zone. The aminopropyl-terminated silicone oil also had 200 ppm of dibutyltin dilaurate added to it. The temperature profile of the heating zones was programmed as follows: zone 1 30° C., zone 2 100° C., zone 3 160° C., zone 4 180° C., zone 5 160° C., zone 6 125° C. The rotational speed was 50 rpm. Taken off from the die of the extruder was colorless polydimethylsiloxane-polyurea-polyurethane block copolymer, which was pelletized after cooling. It exhibited a softening point of 110° C. and a tensile strength of 2.1 MPa.

The examples above show that high molecular mass siloxane-urea-urethane block copolymers can be produced in a continuous reactor method. These materials exhibit better mechanical properties and better processing properties than pure siloxane-urea systems.

1-14. (canceled)

15. A process for the substantially solvent free production of an organopolysiloxane/polyurea/polyurethane block copolymer (A) comprising units of the formula (1):
—[[—NR′—X—SiR₂—[—O—SiR₂—]ₙ—X—NR′—CO—NH—Y—NH—CO—]ₐ——[—O-D-O—CO—NH—Y—NH—CO—]_{b}—[—NR-D′-NR—CO—NH—Y—NH—CO—]_{b}——[—NR′—X—SiR₂—[—O—SiR₂—]ₙ—X—NR′—CO—NH—Y—NH—CO—NH—Y—NH—CO—]_{c}]_{d}—
comprising reacting
an aminoalkylpolydiorganosiloxane of the formula (2):
HR′N—X—[SiR₂O]ₙSiR₂—X—NR′H
with diisocyanate of the formula (3):
OCN—Y—NCO
bishydroxy compounds of the formula (4):
HO-D-OH
and optionally, small amounts of diamino compounds of the formula (5):
HRN-D′-NHR,
where
R is a monovalent hydrocarbon radical having 1 to 20 carbon atoms which is unsubstituted or substituted by fluorine or chlorine,
X is an alkylene radical having 1 to 20 carbon atoms, in which nonadjacent methylene units are optionally replaced by —O— groups,
R′ is hydrogen or an alkyl radical having 1 to 10 carbon atoms,
Y is a divalent hydrocarbon radical having 1 to 20 carbon atoms which is unsubstituted or substituted by fluorine or chlorine,
D is an alkylene radical having 1 to 700 carbon atoms which is unsubstituted or substituted by fluorine, chlorine, C₁-C₆ alkyl or C₁-C₆ alkyl esters and in which nonadjacent methylene units are optionally replaced by —O—, —COO—, —OCO— or —OCOO— groups,
D′ is an alkylene radical having 1 to 700 carbon atoms which is unsubstituted or substituted by fluorine, chlorine, C₁-C₆ alkyl or C₁-C₆ alkyl esters and in which nonadjacent methylene units are optionally replaced by —O—, —COO—, —OCO— or —OCOO— groups,
n is a number from 1 to 4000,
a is a number which is at least 1,
b is a number greater than 1,
b′ is a number from 0 to 40,
c is a number from 0 to 30, and
d is a number greater than 0.

16. The process of claim 15, wherein R individually is a methyl, ethyl, vinyl or phenyl radical.

17. The process of claim 15, wherein Y is an aralkylene radical or linear or cyclic alkylene radical having 3 to 13 carbon atoms.

18. The process of claim 16, wherein Y is an aralkylene radical or linear or cyclic alkylene radical having 3 to 13 carbon atoms.

19. The process of claim 15, wherein D is an alkylene radical having 2 to 12 carbon atoms.

20. The process of claim 15, wherein D is a polyoxyalkylene radical, having 20 to 700 carbon atoms.

21. The process of claim 15, wherein n is a number from 25 to 400.

22. The process of claim 15, wherein a is ≦50.

23. The process of claim 15, wherein b is a number from 5 to 50.

24. The process of claim 15, wherein c is ≦10.

25. The process of claim 15, wherein at least one diisocyanate of the formula (5) is selected from the group consisting of isophorone diisocyanate, hexamethylene 1,6-diisocyanate, tetramethylene 1,4-diisocyanate, methylenedicyclohexyl 4,4′-diisocyanate, methylenediphenyl 4,4′-diisocyanate, toluene 2,4-diisocyanate, toluene 2,5-diisocyanate, toluene 2,6-diisocyanate, m-phenylene diisocyanate, p-phenylene diisocyanate, m-xylene diisocyanate, and tetramethyl-m-xylene diisocyanate.

26. The process of claim 15, wherein at least one bishydroxy compound of the formula (4) is selected from the group consisting of polyetherpolyols, polypropylene glycols, polytetramethylenediols, polyesterpolyols, polycaprolactonediols, a,w-OH-terminated polyalkylenes based on polyvinyl acetate, and polyvinyl acetate-ethylene copolymers, polyvinyl chloride copolymers, polyisobutyldiols, and bishydroxyalkylsilicones.

27. The process of claim 15, wherein the reaction takes place with the addition of at least one catalyst selected from the group consisting of dialkyltin compounds, dibutyltin dilaurate, dibutyltin diacetate, amines, N,N-dimethylcyclohexanamine, 2-dimethyl-aminoethanol, and 4-dimethylaminopyridine.

28. The process of claim 15, wherein first the low molecular mass components are mixed together in a reactor and subsequently aminosilicones and the catalyst(s) are metered into the reactor.

29. A constituent in adhesives and sealants, base material for thermoplastic elastomers, additive to polymer blends, coating material or biocompatible material, cable sheaths, hoses, seals, keyboard mats, membranes, membranes with selective gas permeability, antistick coatings, tissue-compatible coatings or flame-retarded coatings, comprising as at least one component thereof, an organopolysiloxane/polyurea/polyurethane block copolymer prepared by the process of claim 15.
